(19) United States
(12) Patent Application Publication
(10) Pub. No.: US 2025/0251316 A1
(43) Pub. Date: Aug. 7, 2025

(54) CRYOGENIC SAMPLING SYSTEM

(71) Applicant: Welker, Inc., Sugar Lane, TX (US)

(72) Inventor: Hung Ngoc Pham, Houston, TX (US)

(21) Appl. No.: 18/985,960

(22) Filed: Dec. 18, 2024

Related U.S. Application Data
(60) Provisional application No. 63/612,048, filed on Dec. 19, 2023.

(51) Int. Cl. G01N 1/20; G01N 1/14; G01N 1/38

(52) U.S. Cl. CPC G01N 1/2042; G01N 1/14; G01N 1/38; G01N 2001/1454; G01N 2001/386

(57) ABSTRACT

A cryogenic sampling system for refrigerated hydrocarbon fluids is provided. The sampling system may utilize a circulation motor to drive movement of a hydrocarbon fluid, for example propane, from a source to a circulation chamber. The hydrocarbon fluid may circulate within the circulation chamber in a cyclical fashion until a portion of the circulating fluid is drawn as a small-volume sample by a sample pump. The circulation chamber may be in thermal contact with and cool the sample pump. The small-volume samples taken by the sample pump may be directed to a sample chamber supplied with a back pressure. Thus, a sample of the hydrocarbon fluid in its liquid phase may be taken from the source and transported to the sample chamber without allowing the hydrocarbon to vaporize (i.e., transition to its gaseous phase) via warming. The sample chamber may be transported to a laboratory for analysis of the sample.

### CROSS-REFERENCE TO RELATED APPLICATION

This application claims the benefit of U.S. Provisional Patent Application No. 63/612,048, filed Dec. 19, 2023, which is incorporated by reference herein in its entirety.

### FIELD OF THE INVENTION

The present disclosure generally relates to a system for sampling refrigerated hydrocarbon fluids. More specifically, the present disclosure relates to a sampling system that can sample hydrocarbon fluids, for example propane, while maintaining the hydrocarbon fluid in its liquid phase during the entirety of the sampling process.

### BACKGROUND OF THE INVENTION

Within the oil and gas industry, there is a common need to sample hydrocarbon fluids for analysis for quality control, safety, and commercial purposes. When sampling hydrocarbon fluids or petroleum products, it is desirable to maintain the sampled product in its liquid phase by controlling the temperature and/or pressure of its environment. If the sampled product vaporizes (i.e., transitions to its gaseous phase) during the sampling process, the product's composition may be altered, the integrity of the sample may be compromised, and accurate data regarding the product being sampled may be harder to obtain. Vaporization during the sampling process can negatively impact the commercial value of the product by, for example, leading to protracted commercial negotiations regarding a questionable sample. As a result, there is a need for systems designed to sample petroleum products that are not vaporized.

To that end, cryogenic pumping has been used for years for commercial and production purposes. However, it has typically involved large-volume, high-capacity pumps (at least in part) because operating a pump in a hostile temperature environment coupled with the demands of small-volume sampling makes the process especially challenging. Small-volume positive displacement pumps for cryogenic sampling purposes have not been available.

Moreover, some petroleum products are more difficult to sample than others. Many petroleum products, including natural gas and crude oil, have been successfully cryogenically sampled. See, for example, U.S. Pat. No. 8,210,058, assigned to Welker Engineering Company. However, the oil and gas industry has struggled to sample certain petroleum products without vaporizing the sampled product during the sampling process.

For example, cryogenic sampling of propane presents a particular challenge. Propane's sensitivity to pressure and temperature causes the product to quickly transition between its liquid and gaseous phases when it is removed from a cooled pipeline. Propane has a boiling point of approximately negative 43.6 degrees Fahrenheit. Thus, under normal conditions (e.g., on a summer day), sampling propane from a refrigerated pipeline without an external cooling or pressurizing means results in virtually instant vaporization of the sample. Sampling propane without allowing vaporization requires addressing the propane at a cold temperature or at high pressure, which has not been done on a repeatable or consistent basis to date. Thus, there is a need for a cryogenic sampling system capable of taking small-volume samples of propane and other hydrocarbon fluids while maintaining the necessary temperature and/or pressure conditions to keep the sampled product in its liquid phase and prevent vaporization throughout the sampling process.

### SUMMARY OF THE INVENTION

To address at least the problems described above, the present disclosure involves a cryogenic sampling system that utilizes a small-volume sampling pump. The system is designed to maintain more challenging petroleum products, like propane, in the liquid phase throughout the sampling process.

The present cryogenic sampling system may be designed to draw hydrocarbon fluids, for example propane, from a refrigerated source using a cold service pump and motor and to cause the refrigerated fluid to circulate within the sampling system. Specifically, the refrigerated fluid may be directed to a circulation chamber where it may circulate in a cyclical fashion. A sample pump may be in fluid communication with the circulation chamber and configured to take small-volume samples of the refrigerated fluid therein. The sample pump may be in thermal contact with the circulation chamber such that the refrigerated fluid within the circulation chamber may cool the sample pump to help prevent vaporization during the sampling process. Once a sample is drawn from the circulation chamber by the sample pump, the sample may be directed to a sample chamber for temporary storage and/or transport. The sample chamber may be provided with a back pressure above the vapor pressure of the sampled product in order to prevent vaporization while the sampled product is held or transported to a laboratory for analysis.

For a fuller understanding of the nature and advantages of the present invention, reference should be made to the ensuing detailed description and accompanying drawings.

### BRIEF DESCRIPTION OF THE DRAWINGS

The accompanying drawings form a part of the specification and are to be read in conjunction therewith, in which like reference numerals are employed to indicate like or similar parts in the various views:

FIG. 1 illustrates a schematic view of a cryogenic sampling system constructed according to the teachings of the present invention.

FIG. 2 illustrates a cross-sectional view of a sample pump of the cryogenic sampling system of FIG. 1.

FIG. 3 illustrates a detailed plan view of an example cryogenic sampling system constructed according to the teachings of the present invention.

### DETAILED DESCRIPTION OF THE INVENTION

In the following description, an example embodiment of the present invention will be described. While this invention is susceptible of embodiments in many different forms, specific embodiments are shown in the drawings and described in detail herein with the understanding that the present disclosure is an exemplification of the principles of the invention. It is not intended to limit the invention to the specific illustrated embodiments. The invention is capable of other embodiments and of being practiced or of being carried out in various ways. The features of the invention disclosed herein in the description, drawings, and claims may be significant, both individually and in any desired combinations, for the operation of the invention in its various embodiments. Features from one embodiment may be used in other embodiments of the invention. Various modifications to the illustrated embodiments will be readily apparent to those skilled in the art, and the generic principles herein may be applied to other embodiments and applications without departing from the embodiments of the invention.

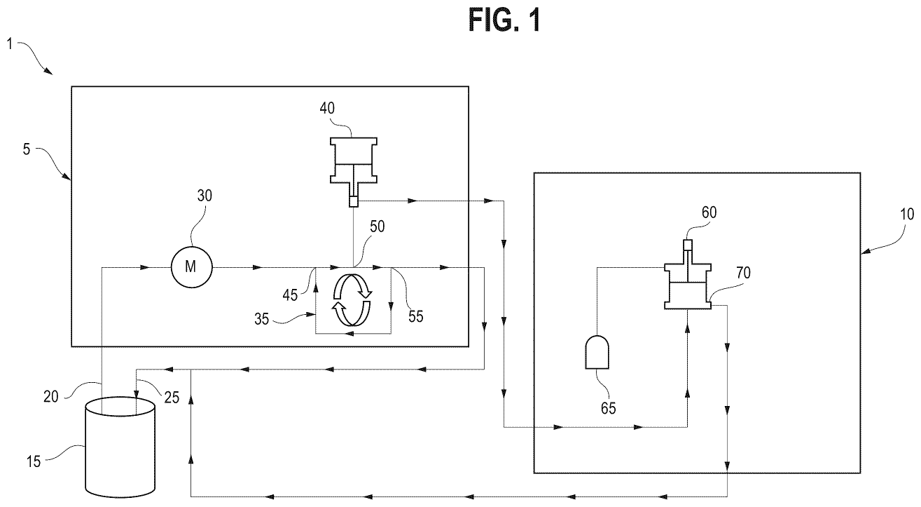

Turning first to FIG. 1, a sampling system 1 may generally comprise a pump stand 5 and a skid 10, each of which may support one or more components of the sampling system 1. The sampling system 1 may be configured to draw samples of a hydrocarbon fluid or petroleum product from a source 15, for example a pipeline or a storage vessel. The sampling system 1 may be in fluid communication with the source 15 via an outflow region 20 and an inflow region 25. For example, fluid may leave the source 15 and enter the sampling system 1 via the outflow region 20, and fluid may leave the sampling system 1 and return to the source 15 via the inflow region 25. The source 15 may be pressurized and/or cooled such that the hydrocarbon fluid or petroleum product therein is maintained in its liquid phase. By way of example, from this point forward the sampling system 1 will be described herein as extracting samples from a source 15 containing propane. However, use of the sampling system 1 to sample other hydrocarbon fluids or petroleum products is envisioned.

The pump stand 5 may support a circulation motor 30, a circulation chamber 35, and a sample pump 40, among other components of the sampling system 1. The circulation motor 30 may be primarily responsible for driving the movement of propane throughout the sampling system 1. For example, the circulation motor 30 may comprise a cold service pump coupled with a motor. The circulation motor 30 may draw propane into the sampling system 1 via the outflow region 20 of the source 15 and then drive the propane toward the circulation chamber 35 in the direction indicated by the arrows in FIG. 1. At least some of the propane drawn from the source 15 may then enter the circulation chamber 35 and begin to circulate or flow in a cyclical manner therein.

The circulation chamber 35 may be in fluid communication with various other components of the sampling system 1. A fluid inlet 45 may be in communication with the circulation chamber 35 and may allow propane from the source 15 to enter the circulation chamber 35. Also, a sample inlet 50 may be in communication with the circulation chamber 35 and may allow a portion of the propane circulating within the circulation chamber 35 to be drawn or extracted by the sample pump 40. Further, a fluid outlet 55 may be in communication with the circulation chamber 35 and may allow at least a portion of the propane circulating within the circulation chamber 35 to be returned to the source 15.

The propane within the circulation chamber 35 may be maintained in a continuous cyclical motion by the circulation motor 30 until it is drawn out of the circulation chamber 35 by the sample pump 40 or returned to the source 15. In other words, propane may cycle through the circulation chamber 35 in a loop which may be interrupted (a) by actuation of the sample pump 40 drawing at least some propane out of the circulation chamber 35 or (b) by propane exiting from the circulation chamber 35 and returning to the source 15 via the inflow region 25.

The schematic view of FIG. 1, which is intended to provide an overview of the operation of the sampling system 1 and is not necessarily drawn to scale, illustrates the circulation chamber 35 as connected to, but otherwise separate from, the sample pump 40. However, the circulation chamber 35 may be in physical and/or thermal contact with the sample pump 40. For example, the sample pump 40 may be substantially cylindrical and the circulation chamber 35 may be provided in the form of a substantially annular body surrounding (e.g., coaxial with) and in direct or indirect contact with an exterior surface of the sample pump 40. Thus, due to the contact between the circulation chamber 35 and the sample pump 40, the cooled propane circulating within the circulation chamber 35 may prevent vaporization during the sampling process by refrigerating the sample pump 40 and, consequently, refrigerating any propane contained within or moving through the sample pump 40. Because the circulation chamber 35 serves to cool the sample pump 40, there is a need to maintain a consistent cooled temperature within the circulation chamber 35 and to prevent the propane within the circulation chamber 35 from warming. Therefore, in some embodiments, the circulation chamber 35 may be insulated. For example, the circulation chamber 35 may be a Dewar chamber.

Additionally, recycling of the propane within the circulation chamber 35 may help to prevent gradual warming of the circulation chamber 35 and/or the propane within. At least a portion of the propane circulating within the circulation chamber 35 may be recycled, i.e., returned from the circulation chamber 35 to the source 15, either periodically or continuously. At any given moment, or during any given period of time, the volume of recycled propane that exits the circulation chamber 35 via the fluid outlet 55 and returns to the source 15 may be substantially equal to a replacement volume of freshly cooled propane concurrently entering the circulation chamber 35 from the source 15 via the fluid inlet 45. By recycling propane in this way, the propane circulating within the circulation chamber 35 may be maintained below a threshold temperature required to prevent vaporization during the sampling process.

Propane may exit the circulation chamber 35 upon actuation of the sample pump 40. The sample pump 40 may be uniquely designed to take small-volume, periodic samples (e.g., to take a “bite”) out of the refrigerated propane circulating within the circulation chamber 35. The refrigerated sample may then be directed to a sample chamber 60 which may be positioned on the skid 10 of the sampling system 1. A pressure tank 65 may be configured to provide a back pressure thereto by injecting a pressurized fluid to pre-charge the sample chamber 60. The pressurized fluid may preferably be a gas; for example, the pressurized fluid may be pressurized nitrogen. The sample chamber 60 may be coupled to and in fluid communication with the pressure tank 65, which may also be positioned on the skid 10. Thus, the pressure tank 65 may be configured to provide or maintain a pressure within the sample chamber 60 greater than the vapor pressure of the propane (or other product being sampled). That way, the sample chamber 60 may be capable of holding the refrigerated sample in its liquid phase and preventing vaporization.

Once the refrigerated sample drawn by the sample pump 40 is deposited in its liquid phase into the sample chamber 60, the pressurized sample may be transferred from the sample chamber 60 to a pressurized transport container (not shown). The container can then be transported to a laboratory or other location for analysis of the sample. The sample chamber 60 may also be equipped with an outlet 70 through which the sampled propane may be discharged from the sample chamber 60 and return to the source 15.

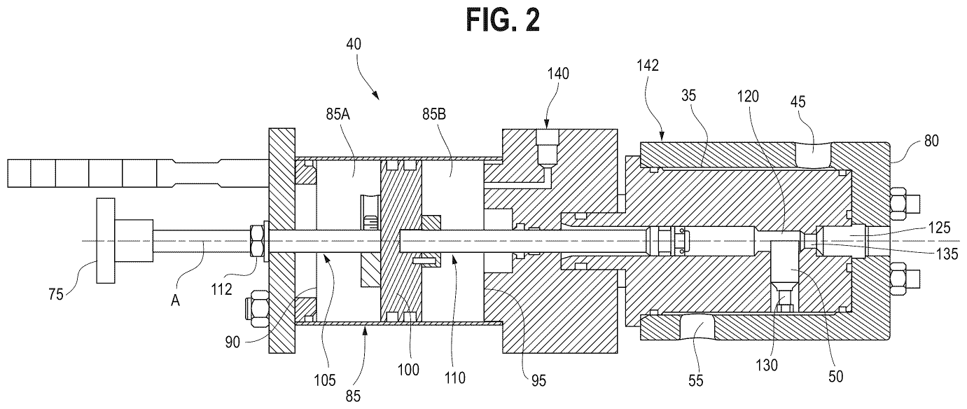

Turning to FIG. 2, a cross-sectional view of the sample pump 40 of FIG. 1 is shown. The sample pump 40 may have a first end 75 and a second end 80 opposing the first end 75. The sample pump 40 may include a chamber 85 having a first end 90 and a second end 95. The chamber 85 may be positioned within the sample pump 40 proximate to the first end 75. A piston 100 (e.g., a motor piston 100) may be positioned within the chamber 85. The motor piston 100 may be movable between the first and second ends 90, 95 of the chamber 85. Thus, the motor piston 100 may serve to divide the chamber 85 into a first subchamber 85A and a second subchamber 85B. While the chamber 85 may have a fixed overall volume, the volume of each of the first and second subchambers 85A, 85B may vary depending on the position of the motor piston 100 between the first and second ends 90, 95 of the chamber 85.

The sample pump 40 may further include a rod 105 and a shaft 110. Both the rod 105 and the shaft 110 may be coupled to the motor piston 100. The rod 105 and the shaft 110 may be substantially parallel with respect to one another and, in some embodiments, the rod 105 and the shaft 110 may extend along a central longitudinal axis A of the sample pump 40. The rod 105 may extend away from the motor piston 100 in the direction of the first end 75 of the sample pump 40, and the shaft 110 may extend away from the motor piston 100 in the direction of the second end 80 of the sample pump 40. In some embodiments, at least a portion of the exterior of the rod 105 may be threaded. For example, the threaded portion of the rod may be positioned proximate to the first end 75 of the sample pump 40 and may be configured to receive a volume adjustment nut 112. The volume adjustment nut 112 may have an interior surface that is at least partially threaded, and the threading of the interior surface of the volume adjustment nut 112 may complement or be configured to engage the threading of the rod 105. Thus, when received by the rod 105, the volume adjustment nut 112 may be used to adjust a volume of a collection chamber 120, into which samples of propane from within the circulation chamber 35 may be drawn.

More particularly, turning the volume adjustment nut 112 in a first direction may cause the rod 105 to translate linearly toward the second end 80 of the sample pump 40. Due to the coupling between the rod 105, the motor piston 100, and the shaft 110, the linear translation of the rod 105 may translate to the motor piston 100 and thus the shaft 110. In this way, turning the volume adjustment nut 112 in the first direction may decrease the volume of the collection chamber 120. Similarly, turning the volume adjustment nut 112 in a second direction opposite the first direction may result in linear translation of the rod 105, motor piston 100, and shaft 110 toward the first end 75 of the sample pump 40. Thus, turning the volume adjustment nut 112 in the second direction may increase the volume of the collection chamber 120.

In some embodiments, the circulation chamber 35 may be positioned proximate to the second end 80 of the sample pump 40 and may be communicably coupled to the fluid inlet 45, sample inlet 50, and fluid outlet 55. The fluid inlet 45 may allow propane drawn from the source 15 by the circulation motor 30 to enter the circulation chamber 35, and the fluid outlet 55 may allow propane circulating within the circulation chamber 35 to be recycled back to the source 15 (see FIG. 1). The sample pump 40 may further include the collection chamber 120 and a sample outlet 125 coupled to the collection chamber 120. Actuation of the motor piston 100 may cause a portion of the propane within the circulation chamber 35 to be drawn out of the circulation chamber 35 and into the collection chamber 120 via the sample inlet 50. The sample deposited in the collection chamber 120 may then be directed away from the sample pump 40 via the sample outlet 125 at which point the sample may travel to the pressurized sample chamber 60.

The sample pump 40 may also include a first check valve 130 positioned between the circulation chamber 35 and the collection chamber 120, and a second check valve 135 positioned between the collection chamber 120 and the sample outlet 125. The first and second check valves 130, 135 may prevent backflow of the propane. For example, the first check valve 130 may prevent propane from flowing from the sample inlet 50 back into the circulation chamber 35, and the second check valve 135 may prevent propane from flowing from the sample outlet 125 back into the collection chamber 120. The sample pump 40 may further include a first instrument supply 140 and a second instrument supply (not shown) positioned proximate to the first end 75 of the sample pump 40. The first instrument supply 140 and second instrument supply may provide a connection point where one or more sensors may be coupled to the sampling system 1. For example, the first instrument supply 140 may also provide a connection point for a pressure gauge, temperature sensor, or any other suitable sensor to monitor variables impacting the function of the sampling system 1.

In some embodiments, the circulation chamber 35 and/or the sample pump 40 (or individual components thereof) may be insulated by an insulating material 142. In the example of FIG. 2, the circulation chamber 35 may be substantially annular, and the insulating material 142 may be substantially annular and configured to encircle at least a portion of the circulation chamber 35. However, in other embodiments, the insulating material 142 may be provided in other forms and may be positioned in any suitable location.

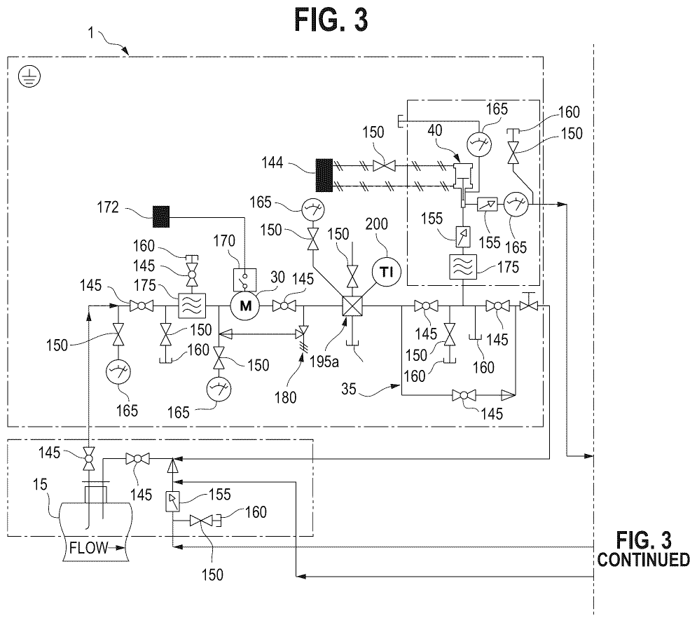

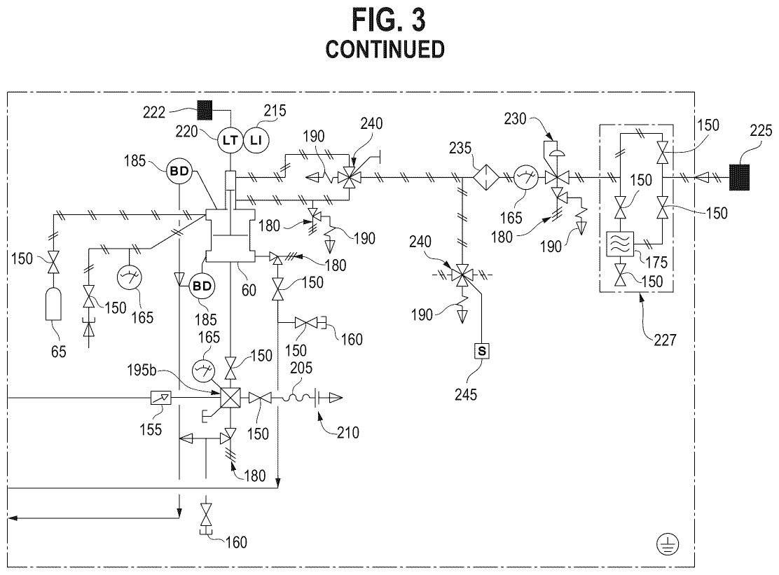

FIG. 3 provides a detailed plan view of an example sampling system 1. As shown, the sampling system 1 may include the pump stand 5 and the skid 10, each of which may support one or more components of the sampling system 1. The circulation motor 30 may draw propane from a refrigerated and/or pressurized source 15 into the circulation chamber 35 and may cause the propane to circulate within the circulation chamber 35 in a loop. The circulation chamber 35 may be in thermal contact with the sample pump 40 such that the propane circulating within the circulation chamber 35 cools the sample pump 40. The sample pump 40 may be configured to extract small-volume samples from the propane within the circulation chamber 35 and direct those samples to the sample chamber 60. For example, the sample pump 40 may be coupled to or in communication with an actuator 144 configured actuate (e.g., hydraulically, pneumatically, etc.) the sample pump 40. A pressure tank 65 may be coupled to the sample chamber 60 and supply the sample chamber with a back pressure above the vapor pressure of the sampled propane. Thus, the sample chamber 60 may be capable of holding the sampled propane in its liquid phase so that the sample can be transported to a laboratory for analysis.

The sampling system 1 may include one or more valves, such as one or more ball valves 145, one or more needle valves 150, and/or one or more check valves 155 arranged to control the flow of fluids through the sampling system 1. In some embodiments, a plug 160 may be associated with (e.g., positioned adjacent or proximate to) one or more ball valves 145, needle valves 150, and/or check valves 155, and one or more plugs 160 may be arranged in any location within the sampling system 1 (e.g., to impede or block a flow therethrough). The sampling system 1 may also include one or more pressure gauges 165 configured to measure a localized pressure at one or more locations within the sampling system 1.

A motor starter 170 may be configured to operate the motor 30, and the motor starter 170 may be operable to turn on the motor 30 and draw fluid from the source 15 into the circulation chamber 35. For example, the motor starter 170 may be in communication with a power source 172 configured to supply power to the motor starter 170 and/or the motor 30. In some embodiments, one or more filters 175 may be arranged within the sampling system 1 to filter the fluids drawn from the source 15 (e.g., before and/or after the fluid enters the circulation chamber 35).

The sampling system 1 may further include safety features such as one or more pressure release valves 180, one or more burst discs 185, and/or other components configured to prevent the sampling system 1 from over-pressurization. In some embodiments, the sampling system 1 may include at least two burst discs 185 positioned adjacent or proximate to the sample chamber 60. Moreover, the sampling system 1 may include one or more vents 190 that open to external or atmospheric conditions.

The sampling system 1 may include one or more manifold blocks 195 configured to control and distribute flows within the sampling system 1. For example, a first manifold block 195a may be positioned between the motor 30 and the circulation chamber 35, and a second manifold block 195b may be positioned between the sample pump 40 and the sample chamber 60. In some embodiments, the first manifold block 195a may be coupled to a temperature indicator 200 configured to measure and/or display a temperature of fluids within the first manifold block 195a or proximate thereto. At least a portion of the fluid that enters the first manifold block 195a may be directed to the circulation chamber 35 to be sampled by the sample pump 40. The second manifold block 195b may be positioned to receive or intercept fluid that leaves the sample pump 40, and at least a portion of the fluid that passes through the second manifold block 195b may be directed to the sample chamber 60. Additionally, in some embodiments, the second manifold block 195b may be in communication with a flex line 205 having a quick connect 210 that enables an operator to draw off a portion of the sampled fluid before the sampled fluid reaches the sample chamber 60.

The sampling system 1 may include a level indicator 215 configured to monitor a level of fluid within the sample chamber 60. The level indicator 215 may be in communication with a level transmitter 220 configured to transmit the data collected by the level indicator 215 to an external device 222 (e.g., a laptop, smartphone, tablet, or other device). In some embodiments, the sampling system 1 may include an air inlet 225 configured to receive an external source of pressurized air (not shown). For example, pressurized air may enter a filter or dryer subassembly 227 via the air inlet 225. The sampling system may include a pressure regulator 230 and an air lubricator 235 positioned proximate to the dryer subassembly 227 and may facilitate pressurization of the sampling system 1 (or portions thereof). For example, the pressurized air may travel from the dryer subassembly 227 through the pressure regulator 230 and/or the air lubricator 235 before entering or being utilized by other components of the sampling system 1. In some embodiments, one or more four-way valves 240 may be arranged proximate to the pressure regulator 230 and air lubricator 235. The four-way valve 240 may be operated by a solenoid 245 or by other suitable mechanisms.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A cryogenic sampling system for sampling a hydrocarbon fluid from a source, the sampling system comprising:
a circulation chamber;
a sample chamber;
a circulation motor configured to direct the hydrocarbon fluid from the source to the circulation chamber; and
a sample pump in thermal contact with the circulation chamber, the sample pump configured to direct small-volume samples of the hydrocarbon fluid from the circulation chamber to the sample chamber,
wherein the sampling system maintains the hydrocarbon fluid in its liquid phase between the hydrocarbon fluid exiting the source and the hydrocarbon fluid being deposited in the sample chamber.

2. The cryogenic sampling system of claim 1, wherein the circulation motor drives a cold service pump configured to draw the hydrocarbon fluid from the source.

3. The cryogenic sampling system of claim 1, wherein the sample pump is substantially cylindrical and the circulation chamber is substantially annular.

4. The cryogenic sampling system of claim 3, wherein the circulation chamber at least partially surrounds the sample pump, and wherein the circulation chamber and the sample pump are in direct physical contact.

5. The cryogenic sampling system of claim 1, wherein refrigerated hydrocarbon fluid within the circulation chamber cools the sample pump.

6. The cryogenic sampling system of claim 1, wherein the sample chamber is supplied with a back pressure to maintain the hydrocarbon fluid within the sample chamber in its liquid phase.

7. The cryogenic sampling system of claim 6, wherein the sample chamber is in communication with a pressure tank configured to supply the back pressure.

8. The cryogenic sampling system of claim 1, wherein the sample chamber includes an outlet in communication with the source such that undesirable samples can be returned to the source.

9. The cryogenic sampling system of claim 1, wherein the circulation chamber includes at least one outlet for returning hydrocarbon fluid to the source, and wherein hydrocarbon fluid is periodically recycled from the circulation chamber to the source and replaced by fresh hydrocarbon fluid from the source such that the hydrocarbon fluid circulating within the circulation chamber is maintained below a threshold temperature.

10. The cryogenic sampling system of claim 1, wherein the circulation chamber includes:
an inlet for receiving hydrocarbon fluid from the source;
a first outlet for returning hydrocarbon fluid to the source; and
a second outlet in communication with the sample pump, the second outlet enabling the sample pump to direct a portion of the hydrocarbon fluid within the circulation chamber to the sample chamber.

11. A pump for a cryogenic sampling system for sampling a hydrocarbon fluid from a source, the pump comprising:
a body defined by a first end and a second end;
a chamber positioned proximate to the first end;
a piston movably positioned within the chamber;
a circulation chamber in communication with the source positioned proximate to the second end and surrounding at least a portion of the pump;
a sample inlet in communication with the circulation chamber; and
a collection chamber in communication with the sample inlet,
wherein actuation of the piston causes the pump to direct a small-volume sample of the hydrocarbon fluid from the circulation chamber to the collection chamber via the sample inlet.

12. The pump of claim 11, wherein the circulation chamber is in thermal contact with at least a portion of the pump.

13. The pump of claim 12, wherein refrigerated hydrocarbon fluid within the circulation chamber cools the pump.

14. The pump of claim 11, wherein the collection chamber is in communication with a sample outlet.

15. The pump of claim 14, wherein the sample outlet is in communication with a sample chamber configured to retain the hydrocarbon fluid sampled by the pump, the sample chamber supplied with a back pressure to maintain the sampled hydrocarbon fluid in its liquid phase.

16. The pump of claim 15, wherein the sample inlet and the sample outlet each have a check valve configured to prevent a reverse flow of hydrocarbon fluid.

17. The pump of claim 11, wherein the circulation chamber includes at least one inlet for receiving hydrocarbon fluid from the source and at least one outlet for returning hydrocarbon fluid to the source.

18. The pump of claim 17, wherein hydrocarbon fluid is continuously recycled from the circulation chamber to the source via the at least one outlet and replaced with new hydrocarbon fluid entering the circulation chamber via the at least one inlet, such that a temperature of the hydrocarbon fluid circulating within the circulation chamber is maintained below a threshold temperature.

19. The pump of claim 11, further comprising a volume adjustment nut configured to facilitate adjustment of a volume of the collection chamber.

20. A method of sampling a hydrocarbon fluid without allowing the product to vaporize, the method comprising:
drawing hydrocarbon fluid from a refrigerated source using a cold service pump and motor;
circulating the hydrocarbon fluid within a circulation chamber;
taking a small-volume sample of the hydrocarbon fluid within the circulation chamber using a sample pump; and
directing the small-volume sample to a collection chamber,
wherein the circulation chamber is in thermal contact with the sample pump such that the refrigerated hydrocarbon fluid within the circulation chamber cools the sample pump, and
wherein the collection chamber is supplied with a back pressure to prevent vaporization of the sampled product.
